(19) United States
(12) Patent Application Publication
(10) Pub. No.: US 2012/0105741 A1
(43) Pub. Date: May 3, 2012

(54) TELEVISION, ELECTRONIC DEVICE

(75) Inventor: Mitsuyoshi Takao, Hidaka-shi (JP)

(73) Assignee: Kabushiki Kaisha Toshiba, Tokyo (JP)

(21) Appl. No.: 13/190,870

(22) Filed: Jul. 26, 2011

(30) Foreign Application Priority Data
Oct. 29, 2010 (JP) 2010-244304

(51) Int. Cl. H04N 5/64

(52) U.S. Cl. 348/836; 348/E05.128

(57) ABSTRACT

According to one embodiment, a television includes a display unit, a supporting portion and a swivel unit provided between the supporting portion and the display unit and connecting the display unit to be rotatable with respect to the supporting portion. The swivel unit further includes a first member, a second member, and a first lubricating member. The first lubricating member includes a first portion provided between the shaft portion and the main body, a second portion provided between the first surface of the first member, and the overlying portion, and a projecting portion projecting from the second portion and fit into the receiving portion to inhibit the first portion and the second portion from rotating with respect to the first member.

### CROSS-REFERENCE TO RELATED APPLICATIONS

This application is based upon and claims the benefit of priority from Japanese Patent Application No. 2010-244304, filed Oct. 29, 2010; the entire contents of which are incorporated herein by reference.

### FIELD

Embodiments described herein relate generally to a thin television comprising a display panel.

### BACKGROUND

Some of electronic devices such as televisions employ a swivel as a structure to rotate a display unit in a horizontal direction in order to adjust the position of the display unit for a better view for the watcher. Further, there are a great number of models of displays for personal computers which employ a swivel.

However, swivels of the general type not only involve a large-scale structure but also a great number of parts in many cases. Under these circumstances, there have been the needs for improvement for such swivels.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary front view of a television as an example of an electronic device according to an embodiment;

FIG. 2 is an exemplary partially cut-away side view of the television shown in FIG. 1;

FIG. 3 is an exemplary cross-sectional view of swivel unit and its surrounding structure shown in FIG. 4 taken along line F3-F3;

FIG. 4 is an exemplary perspective view showing the swivel unit of the television shown in FIG. 1;

FIG. 5 is an exemplary decomposed perspective view showing the swivel shown in FIG. 4;

FIG. 6 is an exemplary perspective view showing a second member of the swivel unit shown in FIG. 5;

FIG. 7 is an exemplary top view showing a first member of the swivel unit shown in FIG. 5;

FIG. 8 is an exemplary top view showing a first lubricating member of the swivel unit shown in FIG. 5;

FIG. 9 is an exemplary perspective view showing the first lubricating member of the swivel unit shown in FIG. 5 from underneath;

FIG. 10 is an exemplary top view showing a second lubricating member of the swivel unit shown in FIG. 5;

FIG. 11 is an exemplary perspective view showing the second lubricating member of the swivel unit shown in FIG. 5 from below;

FIG. 12 is an exemplary perspective view showing a step of fixing a third member of the swivel unit shown in FIG. 4 to a first member and a second member;

FIG. 13 is an exemplary plan view showing an internal state of the swivel unit shown in FIG. 4 from below when the display portion faces the front;

FIG. 14 is an exemplary plan view showing the internal state of the swivel unit shown in FIG. 4 from below when a right-hand side end portion of the display portion rotates forwards;

FIG. 15 is an exemplary plan view showing the internal state of the swivel unit shown in FIG. 4 from below when a left-hand side end portion of the display portion rotates forwards;

FIG. 16 is an exemplary cross sectional view of surroundings of a swivel unit of a television as an example of an electronic device according to a second embodiment;

FIG. 17 is an exemplary front view of a television as an example of an electronic device according to a third embodiment;

FIG. 18 is an exemplary cross sectional view of surroundings of a swivel unit of the television shown in FIG. 17; and

FIG. 19 is an exemplary cross sectional view of surroundings of a swivel unit of a television as an example of an electronic device according to a fourth embodiment.

### DETAILED DESCRIPTION

Various embodiments will be described hereinafter with reference to the accompanying drawings.

In general, according to one embodiment, a television includes a display unit, a supporting portion and a swivel unit provided between the supporting portion and the display unit and connecting the display unit to be rotatable with respect to the supporting portion. The swivel unit further includes a first member, a second member, and a first lubricating member. The first lubricating member includes a first portion provided between the shaft portion and the main body, a second portion provided between the first surface of the first member, and the overlying portion, and a projecting portion projecting from the second portion and fit into the receiving portion to inhibit the first portion and the second portion from rotating with respect to the first member.

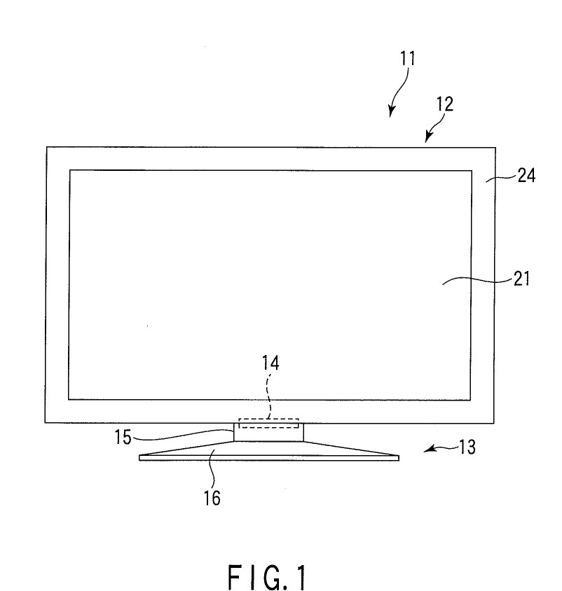

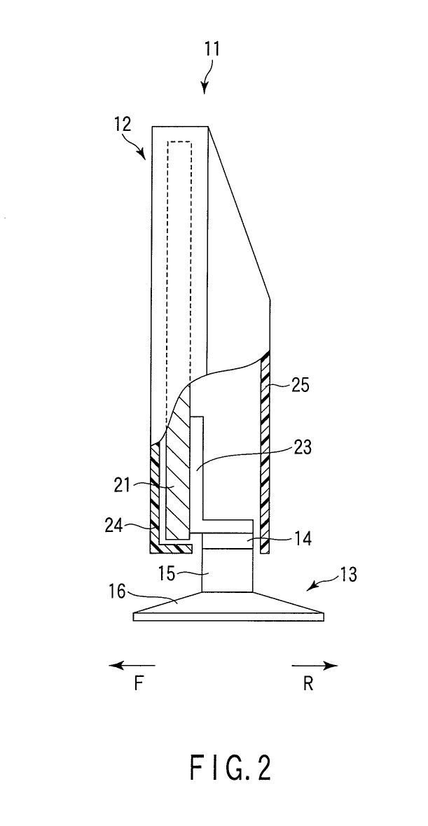

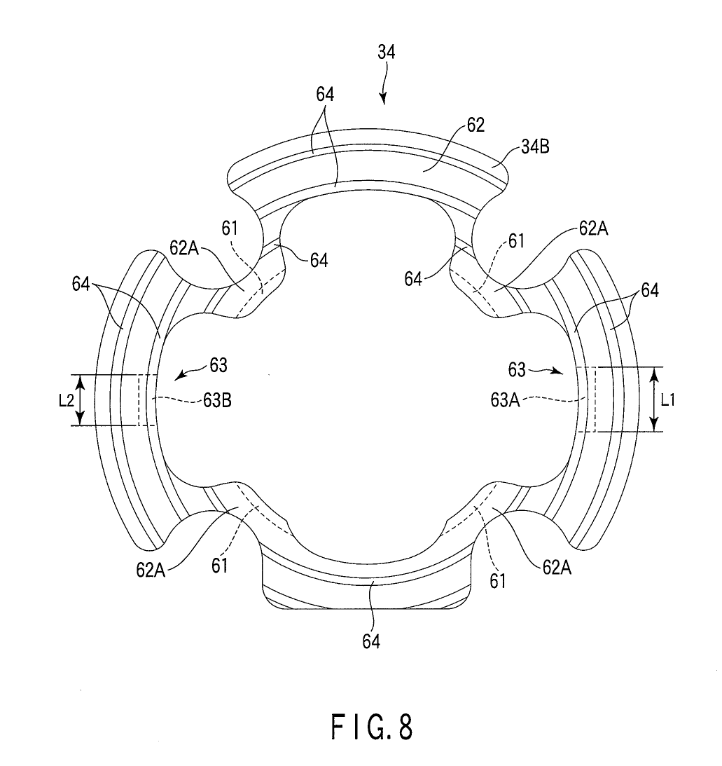

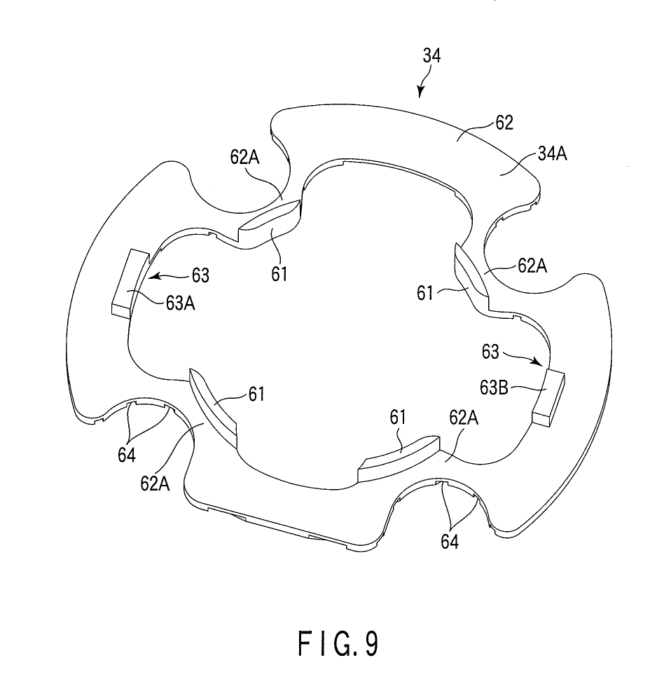

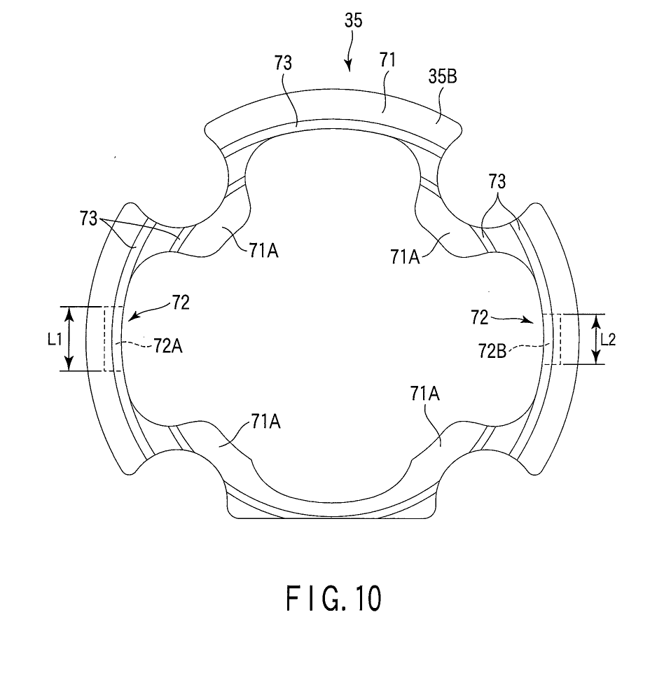

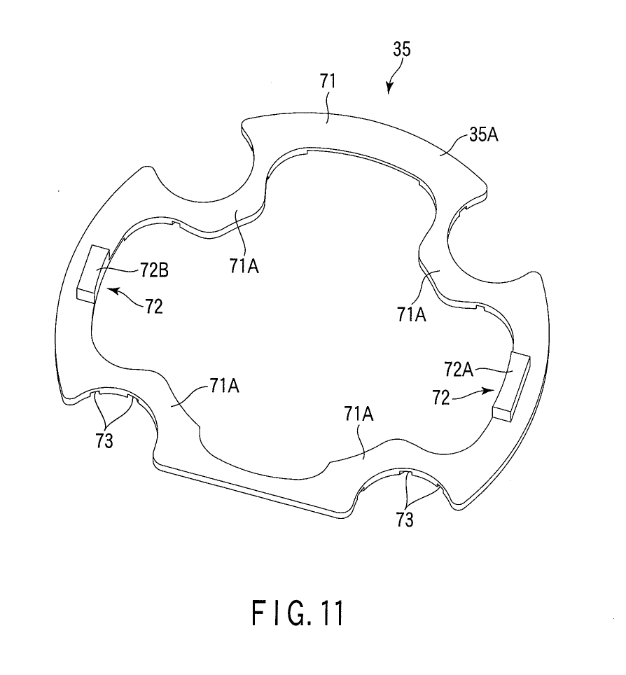

Embodiments of the television as an example of the electronic device will now be described with reference to FIGS. 1 to 15. As shown in FIG. 1, a television 11 according to this embodiment is a thin display device having a rectangular appearance. As shown in FIGS. 1 and 2, the television 11 comprises a display unit 12, a stand 13 which is an example of a support portion which supports the display unit 12, and a swivel unit (joint portion) 14 connected between the stand 13 and the display unit 12. The swivel unit (joint portion) 14 connects the stand 13 and the display portion 12 so that the display unit 12 can rotate with respect to the stand 13. In FIG. 2, the left-hand side in the drawing is a front side F of the television 11, and the right-hand side is a rear side R of the television 11.

The stand 13 comprises a neck portion 15 having substantially a cylindrical shape and a leg portion 16 which is brought into direct contact with a table or the like, on which the television 11 is placed.

The display unit 12 comprises a display panel 21, a control unit mounted on, for example, a rear surface of the display panel 21, a frame 23 fixed to a lower portion of the rear surface of the display panel 21, a framework member 24 having a rim-like shape, which covers a front side of the display panel 21, and a back cover 25 which covers the rear surface of the display panel 21. The frame 23 is a small piece bent into, for example, an letter “L” shape and is fixed to the central portion of the lower end of the display panel 21. The frame 23 secures the display panel 21 to an upper end of the swivel unit 14. The framework member 24 and the back cover 25 form a housing which gives rise to an enclosure of the television 11.

In this embodiment, the display panel 21 is, for example, a liquid crystal panel having, for example, a rectangular plate shape. The display panel 21 may be of some other type such as a plasma display panel or an organic EL panel.

The control unit comprises a plurality of printed circuit boards independent from each other, such as a tuner board, a system substrate and a power circuit board. The tuner board, system substrate and power circuit board are disposed at predetermined positions respectively on the rear surface of the display panel 21.

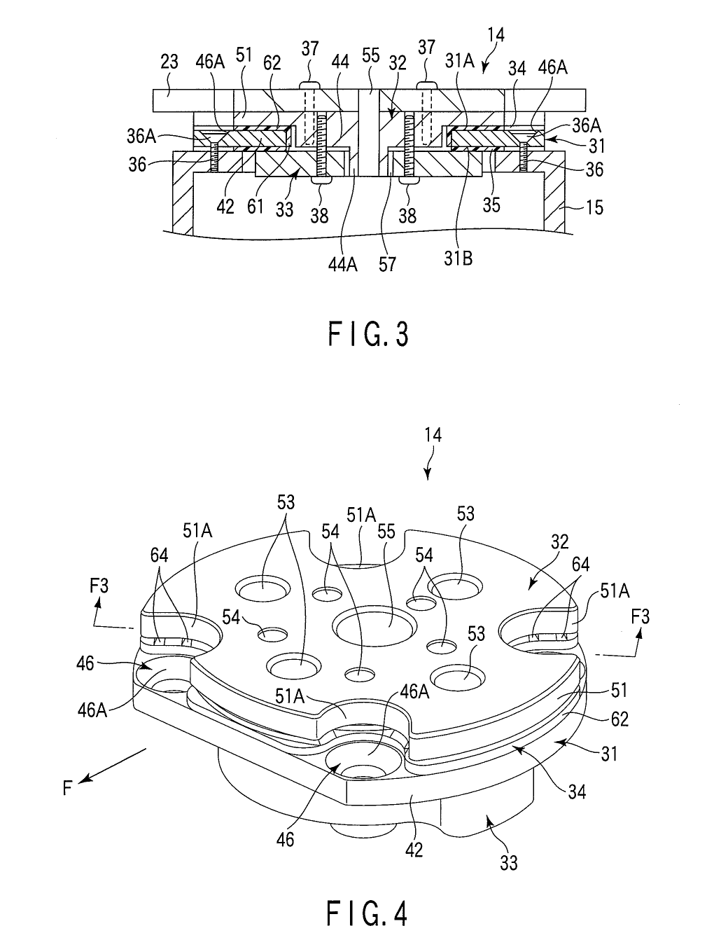

As shown in FIGS. 3 to 5, the swivel unit 14 comprises, for example, a first member 31 having substantially a ring-shape, a second member 32 comprising a shaft portion (fit portion) 44 put through an inner side of the first member 31, a third member 33 provided to overlay on a second surface 31B of the first member 31, a first lubricating member (intermediate member) 34 provided between the first member 31 and the second member 32, a second lubricating member (second intermediate member) 35 provided between the first member 31 and the third member 33, a first screw 36 having a flat-head shape, which secures the first member 31 to the stand 13, a second screw 37 which secures the second member 32 to the display unit 12 and a third screw 38 which secures the second member 32 and the third member 33 to each other. The third screw 38 secures the second member 32 and the third member 33 to each other such as to compress the second lubricating member 35 between the first member 31 and the third member 33 and the first lubricating member 34 between the first member 31 and the second member 32.

Grease, though not shown in the figures, is provided between the first lubricating member 34 and the second member 32 and between the second lubricating member 35 and the third member 33, but grease may not be present. The grease improves the durability of the first lubricating member 34 and the second lubricating member 35 and further decreases the frictional force acting between the first lubricating member 34 and the second member 32 and between the second lubricating member 35 and the third member 33.

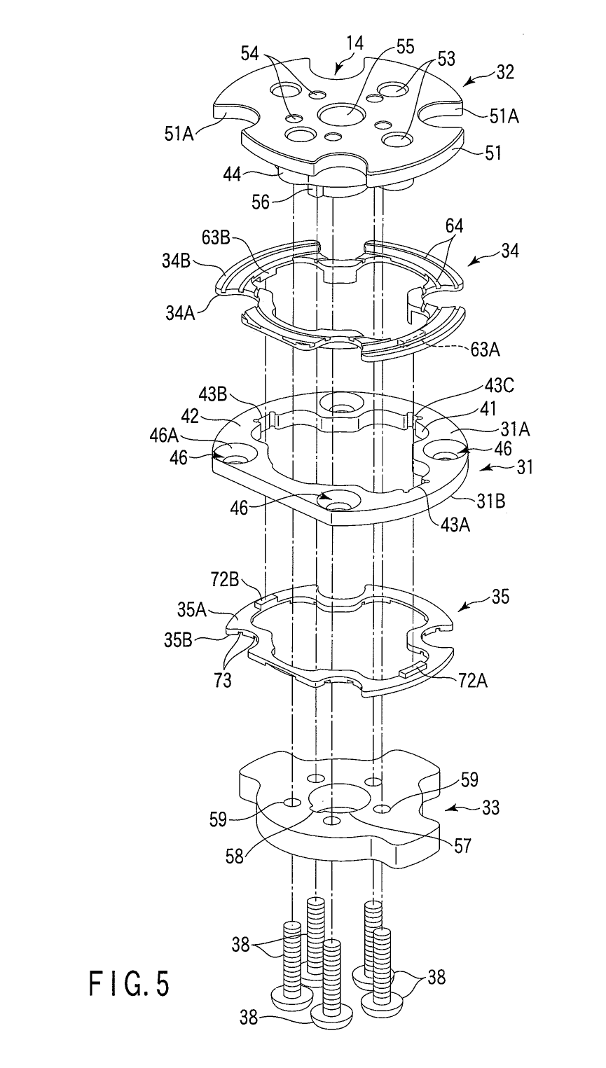

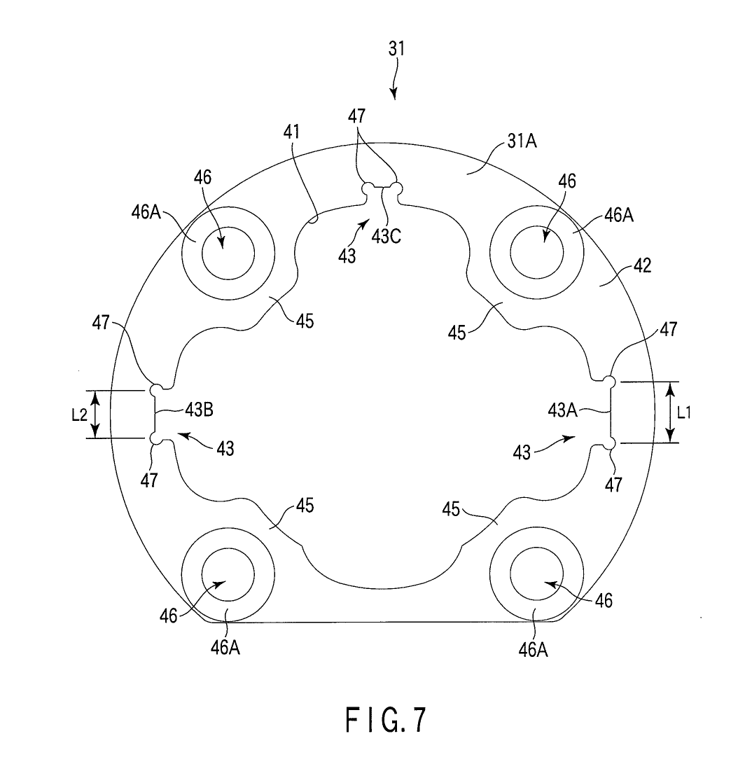

As shown in FIGS. 5 and 7, the first member 31 is formed of, for example, an aluminum alloy into substantially a ring-shaped plate, but it may be made of steel. The first member 31 comprises a first surface 31A and a second surface 31B located on an opposite side thereto. The first member 31 comprises an opening portion 41, a main body 42 which defines the surrounding of the opening portion 41, a plurality of receiving portions 43 formed integrally to be continuous to the opening portion 41, a total of four regulating portions 45 projecting from the main body 42 towards the shaft portion 44 of the second member 32, a total of four first screw holes 46 formed in the vicinities of the regulating portions 45 in the main body 42.

Each of the first screw holes 46 is provided in a part of the respective one of the regulating portions 45. More specifically, each of the first screw holes 46 is provided at a position from the respective regulating portion 45 over to the main body 42. In this embodiment, each of the first screw holes 46 is provided at a position from the respective regulating portion 45 over to the main body 42, but it is alternatively possible that each of the first screw holes 46 is provided in the respective one of the regulating portions 45.

As shown in FIG. 3, each of the first screw holes 46 comprises a cone-shaped recess portion 46A which can receive the head portion 36A of the flat-headed first screw 36. In the portion of the first screw hole 46 other than the recess portion 46A, a female thread is formed. An adjacent pair of regulating portions 45 sandwich a first projecting portion 52 (later explained) of the second member 32 therebetween, thus regulating the rotation angle of the second member 32.

As shown in FIGS. 5 and 7, the receiving portions 43 respectively comprise a first receiving portion 43A, a second receiving portion 43B provided at a position opposing to that of the first receiving portion 43A, and a third receiving portion 43C provided at a position between the receiving portion 43A and the second receiving portion 43B. The first to third receiving portions 43A to 43C are each formed by notching an edge portion of the opening portion 41 further into a rectangular shape. Further, at corners of each of the rectangular receiving portions 43, round notched corner portions 47 are formed respectively. With these round corner portions 47 provided, the remaining of an unnecessary part at the corner portions of the first receiving portion 43A can be prevented, which avoids such a problem of a rectangular projecting portion 63 provided in the first lubricating member 34 not being able to enter thereinto.

The receiving portions 43 respectively comprise the first receiving portion 43A, the second receiving portion 43B opposing to the first receiving portion 43A, and the third receiving portion 43C preliminarily provided at a position therebetween. The second receiving portion 43B is formed to have a width L2 smaller than a width L1 of the first receiving portion 43A. As will be explained later, the first projecting portion 63A of the first lubricating member 34 is fit to the first receiving portion 43A, and the second projecting portion 63B of the first lubricating member 34 is fit to the second receiving portion 43B. The third receiving portion 43C is preliminarily provided in this embodiment, the structure to be fit into the third receiving portion 43C may be provided in each of the first lubricating member 34 and the second lubricating member 35.

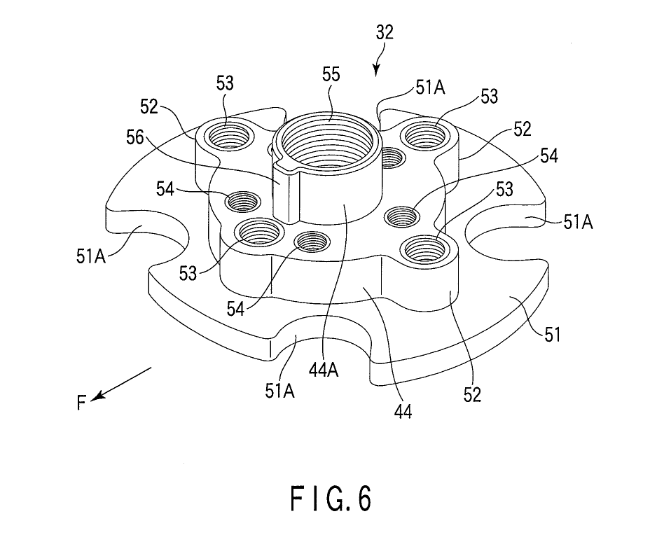

As shown in FIGS. 5 and 6, the second member 32 is formed of, for example, an aluminum alloy and is provided such as to overlay on the first surface 31A of the first member 31. The second member 32 may be made of steel. The second member 32 comprises a shaft portion (fit portion) 44 having substantially a cylindrical shape, which is put to be rotatable in the opening portion 41 of the first member 31, an overlying portion (overlapping portion) 44 having a flat-plate shape, which overlays on the first surface 31A of the first member 31, a total of three first projecting portions 52 each projecting from the shaft portion 44 towards the first member 31, a total of 4 second screw holes 53 provided in the first projecting portions 52 and the shaft portion 44, a total of 5 through holes 54 provided in the shaft portion 44 at uniform pitches, a fixation hole 55 provided at a center of the shaft portion 44 and a second projecting portion 56 projecting from the shaft portion 44. Each of the through holes 54 is provided with a female thread formed therein, with which the distal end portion of the third screw 38 can be engaged into the respective one of the through holes 54. (See FIG. 3.) Similarly, a female thread is formed in an inner side of the fixation hole 55. The fixation hole 55 is used to secure a bolt 81 in the second embodiment.

The shaft portion 44 comprises a cylindrical portion 44A which faces the third member 33, and the diameter of the cylindrical portion 44A is smaller than the diameter of the sections of the shaft portion 44 other than the cylindrical portion. When the swivel unit 14 is assembled, the cylindrical portion 44A is put into a through hole 57 formed in the third member 33. The above-mentioned second projecting portion 56 projects from the cylindrical portion 44A of the shaft portion 44 in its radial direction. The second projecting portion 56 projects towards the front direction F of the television 11. The overlaying portion 51 comprises a total of 4 notch portions 51A. The notch portions 51A serve to expose the first screw holes 46 to outside when the second member 32 is overlaid on the first member 31.

Each of the second screw holes 53 is formed in the respective one of the first projecting portions 52. Further, one of the second screw holes 53 is made in the shaft portion 44. Each of the second screw holes 53 is provided with a female thread formed therein, and a second screw 37 is put through each of the second screw holes 53. (See FIG. 3.)

As shown in FIGS. 4 and 5, the third member 33 and the overlaying portion 51 of the second member 32 sandwich the first member 31 therebetween, so as to avoid the shaft portion 44 of the second member 32 from dropping from the opening portion 41 of the first member 31. The third member 33 is formed of, for example, an aluminum alloy into a thick plate shape, but it may be made of steel.

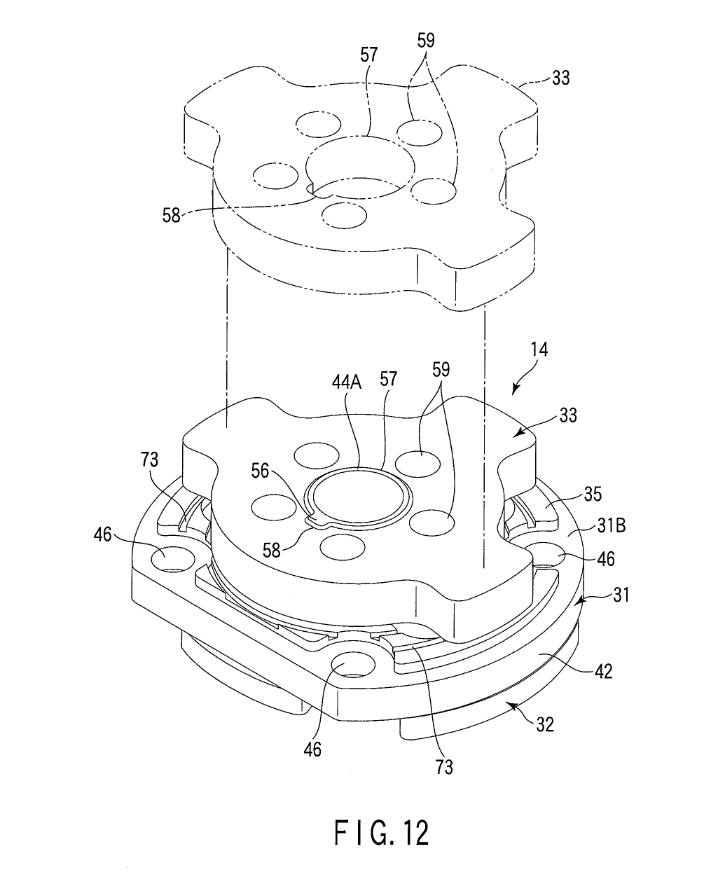

As shown in FIGS. 5 and 12, the third member 33 comprises a circular through hole 57 formed at a central portion thereof, a slot-like engaging portion 58 extending from the through hole 57 towards the radial direction of the through hole 57, and a third screw hole 59 through which a third screw 38 is put. The third screw hole 59 is provided with a female thread formed therein. As the second projecting portion 56 is fit to the engaging portion 58, the third member 33 is prohibited to rotate with respect to the second member 32. With this structure, when the display unit 12 is rotated, the third member 33 can be rotated in synchronization with the second member 32.

As shown in FIGS. 3, 5, 8 and 9, the first lubricating member 34 is formed of a synthetic resin such as polyacetal (POM) into substantially a ring shape. The first lubricating member 34 comprises a first portion 61 provided between the shaft portion 44 of the second member 32 and the main body 42 of the first member 31, a second portion 62 provided between the first surface 31A of the first member 31 and the overlaying portion 51 of the second member 32, and a plurality of projecting portions 63 projecting from the second portion 62, that is, a first projecting portion 63A and a second projecting portion 63B, which are integrated as one unit. The second portion 62 comprises a first detour portion 62A passing through a position outside the first screw hole 46 of the first member 31, and continues to the first portion 61 at the portion most close to the inner side of the first detour portion 62A.

The first projecting portion 63A is formed into a rectangular having a dimension L1 which is just the size fit to the inner side of the first receiving portion 43A. On the other hand, the second projecting portion 63B formed into a rectangular having a dimension L2 which is just the size fit to the inner side of the second receiving portion 43B. That is, the width L2 of the second projecting portion 63B is smaller than the width L1 of the first projecting portion 63A. With this structure, the first lubricating member 34 is properly attached onto the first surface 31A without being attached to the second surface 31B of the first member 31 by error. As the first projecting portion 63A is fit to the first receiving portion 43A and the second projecting portion 63B is fit to the second receiving portion 43B, the first lubricating member 34 is prohibited to rotate with respect to the first member 31.

A plurality of circular first groove portions 64 are provided coaxially in another surface 34B on an opposite side to a surface 34A of the second portion 62 of the first lubricating member 34, which faces the first member 31. With the first groove portions 64 made circular, the contact area between the first lubricating member 34 and the second member 32 can be reduced, thereby reducing the frictional force (resistance). In this manner, the second member 32 can be easily rotated with respect to the first member 31.

Part of the grease applied between the first lubricating member 34 and the second member 32 is kept in the inner side of each of the first groove portions 64. The grease applied between the first lubricating member 34 and the second member 32 is pushed to a radial inner side as well as a radial outer side of the second member 32 as the display unit 12 (the second member) is repeatedly rotated. But, the portion of the grease kept in the inner side of each of the first groove portions 64 remains as it is in the respective positions. While the grease is kept inside the first groove portions 64, the frictional force (resistance) between the first lubricating member 34 and the second member 32 is maintained at low at all times. Further, even in the case where the portion of the grease located in the vicinity of the surface of the first lubricating member 34 is all pushed out over a long period of use. Then, as the higher section surrounding the first groove portions 64 wears off, the grease in the first groove portions 64 is once again supplied to the surface of the first lubricating member 34.

As shown in FIGS. 5, 10 and 11, the second lubricating member 35 is formed of a synthetic resin such as polyacetal (POM) into substantially a ring shape. The second lubricating member 35 comprises a main body portion 71 having substantially a ring shape, and a first protrusion portion 72A and a second first protrusion portion 72B, which protrude from the surface of the main body portion 71. The main body portion 71 comprises a second detour portion 71A passing through a position outside the first screw hole 46 of the first member 31.

The first protrusion portion 72A is formed into a rectangular having a dimension L1 which is just the size fit to the inner side of the first receiving portion 43A. The second protrusion portion 72B is formed into a rectangular having a dimension L2 which is just the size fit to the inner side of the second receiving portion 43B. That is, the width L2 of the second protrusion portion 72B is smaller than the width L1 of the first protrusion portion 72A. With this structure, the second lubricating member 35 is properly attached onto the second surface 31B without being attached to the first surface 31A of the first member 31 by error. As the first protrusion portion 72A is fit to the first receiving portion 43A and the second protrusion portion 72B is fit to the second receiving portion 43B, the second lubricating member 35 is prohibited to rotate with respect to the first member 31.

A plurality of circular second groove portions 73 are provided coaxially in another surface 35B on an opposite side to a surface 35A of the main body portion 71 of the second lubricating member 35, which faces the first member 31. With the second groove portions 73 made circular, the contact area between the first lubricating member 34 and the third portion 33 can be reduced, thereby reducing the frictional force (resistance). In this manner, the third member 33 can be easily rotated with respect to the first member 31.

Part of the grease applied between the second lubricating member 35 and the third member 33 is kept in the inner side of each of the second groove portions 73. The grease applied between the second lubricating member 35 and the third member 33 is pushed out to a radial inner side as well as a radial outer side of the third member 33 as the display unit 12 (the second member 32) is repeatedly rotated. But, the portion of the grease kept in the inner side of each of the second groove portions 73 remains as it is in the respective positions. While the grease is kept inside the second groove portions 73, the frictional force (resistance) between the second lubricating member 35 and the third member 33 is maintained at low at all times. Further, even in the case where the portion of the grease located in the vicinity of the surface of the second lubricating member 35 is all pushed out over a long period of use. Then, as the higher section surrounding the second groove portions 73 wears off, the grease in the second groove portions 73 is once again supplied to the surface of the second lubricating member 35.

The assembling operation of the television 11 according to this embodiment will now be described. In this embodiment, the swivel unit 14, which is assembled in advance as one integrated unit, is mounted to the stand 13 of the television 11. In the assembly of the unit of the swivel unit 14, first, the first lubricating member 34 is secured to the first surface 31A of the first member 31, and the second lubricating member 35 is secured to the second surface 31B of the first member 31. During this operation, the first projecting portion 63A and the second projecting portion 63B of the first lubricating member 34 are fit into the first receiving portion 43A and the second receiving portion 43B of the first member 31. Similarly, from an opposite side, the first protrusion portion 72A and the second protrusion portion 72B of the second lubricating member 35 are fit into the first receiving portion 43A and the second receiving portion 43B of the first member 31. With these operations, the first lubricating member 34 and the second lubricating member 35 are provisionally fixed to the first member 31.

Then, the shaft portion 44 of the second member 32 is plugged into the opening portion 41 of the first member 31 from the direction of the first surface 31A of the first member 31, and further the third member 33 is brought into contact with the second lubricating member 35 on the second surface 31B of the first member 31. As shown in FIG. 12, during this operation, the cylindrical portion 44A and the second projecting portion 56 are fit into the through hole 57 and the engaging portion 58 of the third member 33, respectively. Here, since the first lubricating member 34 and the second lubricating member 35 are provisionally fixed to the first member 31, the operator is not required to keep on pressing the first lubricating member 34 and the second lubricating member 35 during this operation, and therefore the operability in this process is excellent. Then, while the second member 32 is kept in contact with the first lubricating member 34, and the third member 33 kept in contact with the second lubricating member 35, the third screws 38 are fastened into the third screw hole 59 of the third member 33 and the through hole 54 of the second member 32, respectively. In this manner, the first member 31 is interposed between the second member 32 and the third member 33, and thus the swivel unit 14 is completed.

In the following step of the assembly of the television 11, the first screw 36 is fastened into the first screw hole 46 of the first member 31 as show in FIG. 3, and thus the swivel unit 14 is secured to the neck portion 15 of the stand 13. Further, the second screw 37 is fastened into the second screw hole 53 of the second member 32, and the frame 23 of the display unit 12 is secured to the swivel unit 14. Thus, the assembly of the television 11 is completed. It should be noted that each of the above-described assembly process for the swivel unit 14 and the above-described assembly process for the television 11 is merely an example, and various methods other than these may be employed.

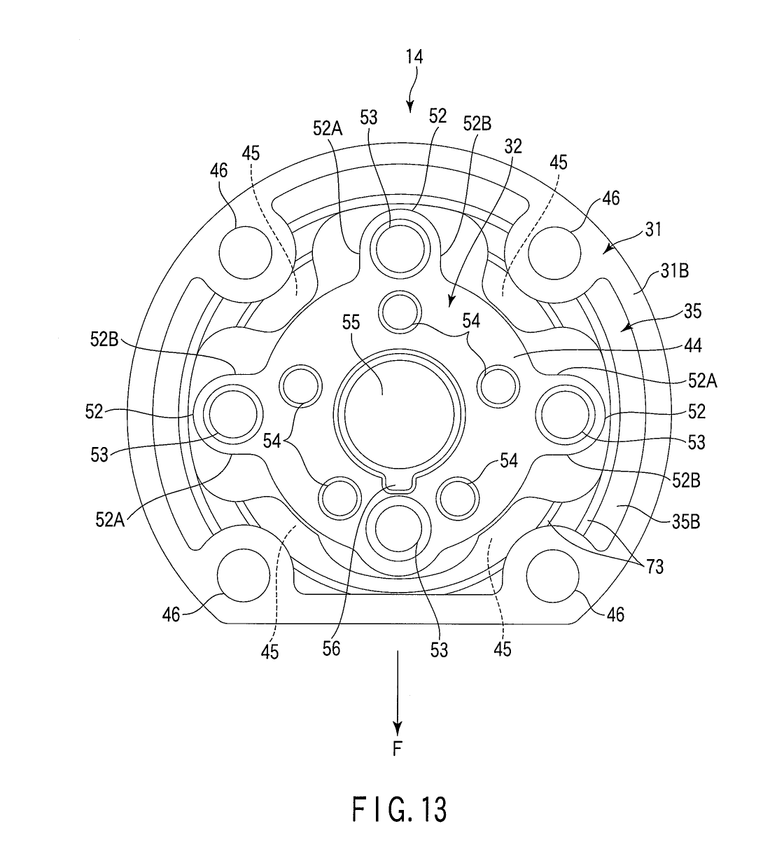

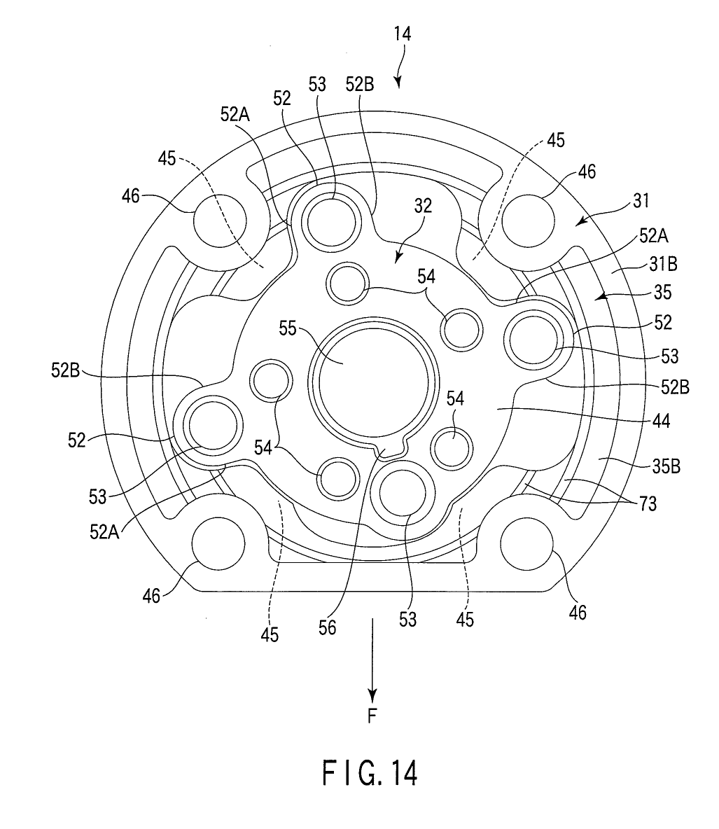

Subsequently, with reference to FIGS. 13 to 15, the operation of the swivel unit 14 of this embodiment will now be described. First, as shown in FIG. 13, while the display unit 12 faces in the front direction, each of the three first projecting portions 52 of the second member 32 is located at a middle position between a respective adjacent pair of regulating portions 45. From this state, when the user rotate the display unit 12 in a horizontal direction to move the right-hand side end portion of the display unit 12 to the near side to the user as viewed from the front, the second member 32 rotates counter-clockwise as shown in FIG. 14 from the state shown in FIG. 13. The maximum rotation angle here is, for example, 10 to 20 degrees from the state in which the display unit 12 faces front. In the state where the right-hand side end portion of the display unit 12 is moved to the most near side to the user, a first side surface 52A of the first projecting portion 52 of the second member 32 abuts against the respective regulating portion 45 of the first member 31.

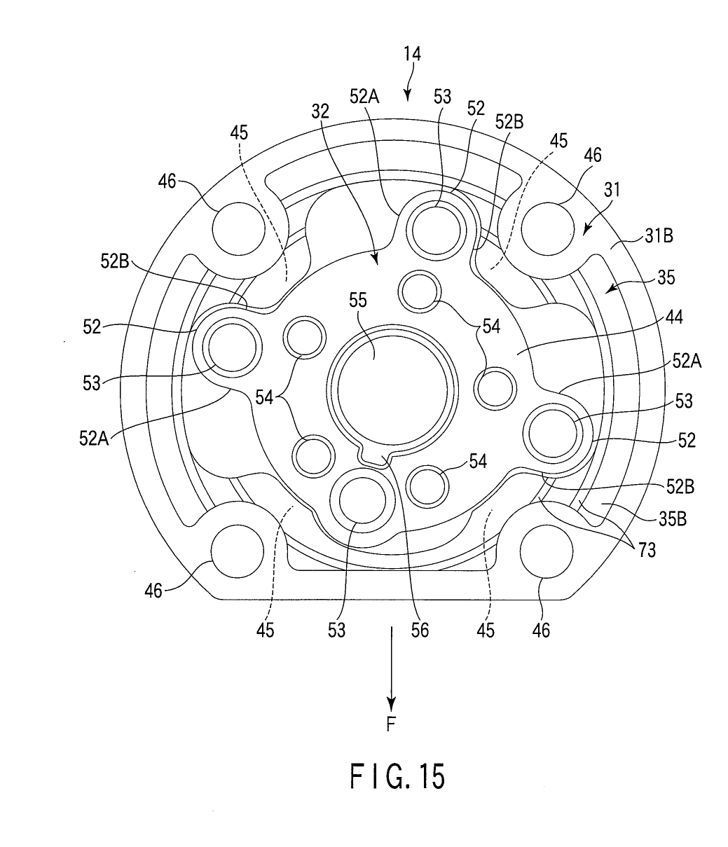

On the other hand, when the user rotate the display unit 12 in a horizontal direction to move the left-hand side end portion of the display unit 12 to the near side to the user as viewed from the front, the second member 32 rotates clockwise as shown in FIG. 15 from the state shown in FIG. 13. The maximum rotation angle here is, for example, 10 to 20 degrees from the state in which the display unit 12 faces front. In the state where the left-hand side end portion of the display unit 12 is moved to the most near side to the user, a second side surface 52B of the first projecting portion 52 of the second member 32 abuts against the respective regulating portion 45 of the first member 31.

In the manner described above, the first lubricating member 34 and the second lubricating member 35 are prevented from being rotated together with the second member 32 and the third member 33 while the display unit 12 is being rotated in the horizontal (lateral) direction. As a result, it is possible to prevent deterioration of the operability actually sensed by the user, such as two-step movement of the display unit 12 (for example, the movement in which the display unit rotates a little in the beginning, stops once, and then rotates greatly), which is caused by displacements of the first lubricating member 34 and the second lubricating member 35. Thus, the sooth rotation of the display unit 12 can be realized.

According to the first embodiment, the electronic device comprises the display unit 12, the support portion and the swivel unit 14 provided between the support portion and the display unit 12 and connecting the display unit 12 to be rotatable with respect to the supporting portion, and the swivel unit 14 further comprises: the first member 31 comprising the opening portion 41, the main body 42 which defines the surrounding of the opening portion 41, the plurality of receiving portions 43 formed in the main body 42, and secured to either one of the supporting portion and the display unit 12; the second member 32 comprising the shaft portion 44 fit to be rotatable to the opening portion 41 and the overlying portion 51 overlying on the first surface 31A of the first member 31, and secured to the other one of the supporting portion and the display unit 12; and the first lubricating member 34 comprising the first portion 61 provided between the shaft portion 44 and the main body 42, the second portion 62 provided between the first surface 31A of the first member 31 and the overlying portion 51, and the plurality of projecting portions 63 projecting from the second portion 62 and fit into the receiving portions 43, respectively, so as to inhibit the first portion 61 and the second portion 62 from rotating with respect to the first member 31.

With the above-described structure, the first lubricating member 34 is prevented from being rotated together with the second member 32. As a result, it is possible to prevent deterioration of the operability actually sensed by the user, that is, such as two-step movement of the display unit 12. Further, the first member 31 and the first lubricating member 34 can be formed into an integrated unit by fitting the projecting portions 63 into the receiving portions 43 of the first member 31, respectively, and therefore the workability in the assembly of the swivel unit 14 can be improved.

Further, the second member 32 comprises the first projecting portions 52 projecting from the shaft portion 44 towards the first member 31, and the first member 31 comprises the pair of regulating portions 45 projecting from the main body 42 towards the shaft portion 44 such as to sandwich the respective one of the first projecting portions 52 therebetween. The pair of regulating portions 45 serve to regulate the rotation angle of the second member 32. With this structure, the regulating portions 45 which regulate the rotation angle of the second member 32 and the first projecting portions 52 are provided inside the first member 31, and therefore the size of the swivel unit 14 can be reduced.

Further, the swivel unit 14 comprises the first screw 36 which secures the first member 31 to either one of the supporting portion and the display unit 12, and the second screw 37 which secures the second member 32 to the other one of the supporting portion and the display unit 12. Each of the regulating portions 45 is provided with the first screw hole 46 through which the first screw 36 is put, and each of the first projecting portions 52 is provided with the second screw hole 53 through which the second screw 37 is put. With this structure, the first projecting portions 52 and the regulating portions 45 can be formed by utilizing the structure to put the first screws 36 and the second screws 37 (that is, the first screw holes 46 and the second screw holes 53). In this manner, the size of the swivel portion 14 can be reduced as compared to the case where the first screw holes 46 and the second screw holes 53 are provided some other sections.

Further, the receiving portions 43 each comprise the first receiving portion 43A and the second receiving portion 43B having a width smaller than that of the first receiving portion 43A, and the projecting portions 63 each comprise the first projecting portion 63A fit into the respective first receiving portion 43A and the second projecting portion 63B fit into the respective second receiving portion 43B and having a width smaller than that of the first projecting portion 63A. With this structure, when the first member 31 and the first lubricating member 34 are integrated in advance as one unit during the assembly of the swivel portion 14, the first lubricating member 34 is properly attached onto the first surface 31A of the first member 31. In this manner, assembling errors can be prevented from occurring during the assembly, and thus the operation efficiency can be further improved.

Further, the first screw holes 46 each comprises the recess portion 46A which can hold the head portion 36A of the first screw 36. With this structure, the head portion 36A of the first screw 36 does not project to an upper side of the first member 31, and thus it is possible to prevent the head portion 36A of the first screw 36 and the overlaying portion 51 of the second member 32 from interfering with each other. It should be noted that if the head portion 36A of the first screw 36 projects to an upper side of the first member 31, it is necessary to avoid the interference between the first screw 36 and the overlaying portion 51 of the second member 32 by increasing the thickness of the second portion 62 of the first lubricating member 34. With the structure of this embodiment, there is no need to increase the thickness of the second portion 62, and thus the thickness of the swivel portion 14 can be reduced, thereby making it possible to realize the downsizing.

Further, the swivel portion 14 comprises the third member 33 overlying on the second surface 31B on the opposite side to the first surface 31A of the first member 31, the second lubricating member 35 comprising the main body portion 71 provided between the second surface 31B of the first member 31 and the third member 33, and the protrusion portions 72 protruding from the main body portion 71 and fit to the receiving portions 43, respectively, so as to inhibit the main body portion 71 from rotating with respect to the first member 31, and the third screws 38 which secure the second member 32 and the third member 33 to each other so as to compress the second lubricating member 35 between the first member 31 and the third member 33.

With the above-described structure, the second lubricating member 35 is prevented from being rotated together with the third member 33. As a result, it is possible to prevent deterioration of the operability actually sensed by the user, that is, such as two-step movement of the display unit 12. Further, the second lubricating member 35 and the first member 31 can be formed into an integrated unit in advance by fitting the protrusion portions 72 of the second lubricating member 35 into the receiving portions 43 of the first member 31, respectively, and therefore the workability in the assembly of the swivel unit 14 can be improved. Furthermore, the second lubricating member 35 is compressed between the first member 31 and the third member 33, and therefore an appropriate torque can be obtained. Therefore, it is possible to prevent such a problem that the display unit 12 rotates when it is not intended so.

The third member 33 comprises the engaging portion 58, and second member 32 comprises the second projecting portion 56 projecting from the shaft portion 44. The second projecting portion 56 fit into the engaging portion 58 so as to prevent the third member 33 from rotating with respect to the second member 32. With this structure, the second member 32 and the third member 33 are secured to each other by the third screws 38, but due to the clearance of the third screws, the movement of the second member 32 and that of the third member 33 do not sometimes accord with each other. As a result of this, deterioration of the operability actually sensed by the user, may be caused, that is, such as two-step rotation movement of the display unit 12. With the structure of this embodiment, the second member 32 and the third member 33 can be moved in synchronization with each other, and therefore it is possible to prevent the deterioration of the operability on the display unit 12 actually sensed by the user, as much as possible.

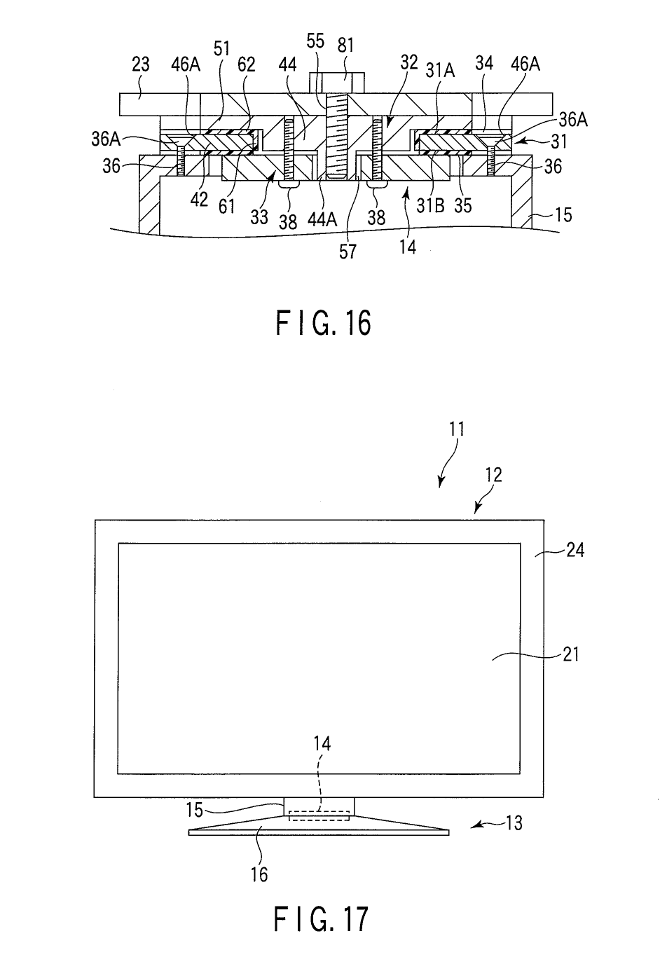

Next, the second embodiment of the electronic device will now be described with reference to FIG. 16. A television 11, which is an example of the electronic device according to the second embodiment is similar to that of the first embodiment in main structure. Therefore, the portions different from those of the first embodiment will be mainly described. Here, the common parts will be designated by the same reference symbol and explanations therefore will be omitted.

In the second embodiment, for the fixation of the swivel portion 14 and the display unit 12, the four second screws 37 are not used but only one bolt 81 is used. The bolt 81 is fastened to a fixation hole 55 of the second member 32 of the swivel unit 14, and thus the frame 23 of the display unit 12 is secured to the swivel portion 14.

According to the second embodiment, due to the high versatility of the swivel unit 14, the display unit 12 can be secured to the swivel unit 14 by a method different from that of the first embodiment. Therefore, the swivel unit 14 can be employed by a plurality of different models, and also it can flexibly deal with design changes or the like.

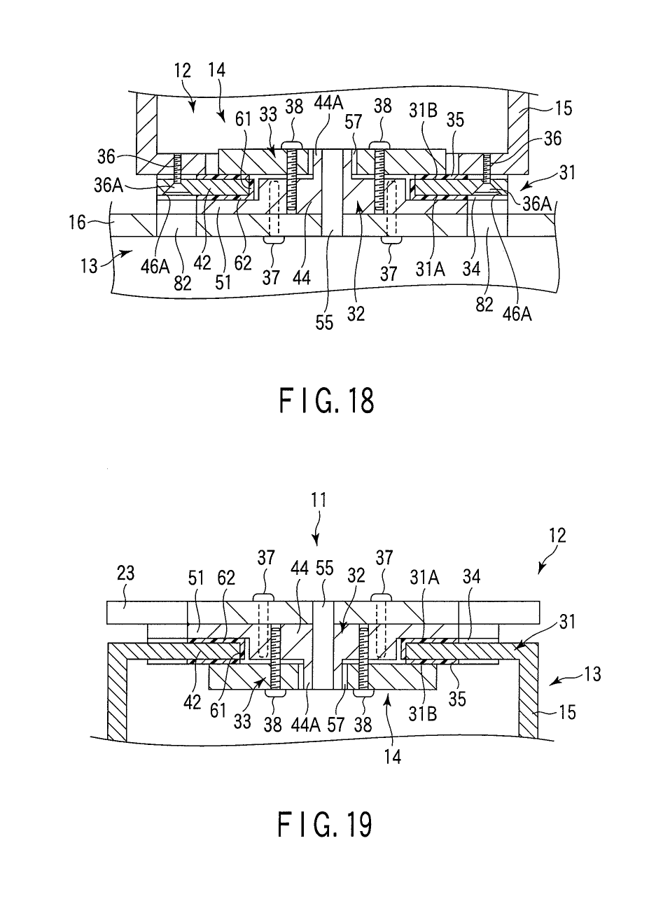

Subsequently, the third embodiment of the electronic device will now be described with reference to FIGS. 17 and 18. A television 11, which is an example of the electronic device according to the third embodiment is similar to that of the first embodiment in main structure. Therefore, the portions different from those of the first embodiment will be mainly described. Here, the common parts will be designated by the same reference symbol and explanations therefore will be omitted.

The television 11 comprises a display unit 12, a stand 13 which is an example of a support portion which supports the display unit 12, and a swivel unit (joint portion) 14 connected between the stand 13 and the display unit 12.

In this embodiment, the stand 13 is a leg portion 16 which is brought into direct contact with a table or the like, on which the television 11 is placed. Further, as shown in FIG. 18, the leg portion 16 comprises operation holes 82 used to operate the first screws 36.

The display unit 12 comprises a display panel 21, a control unit mounted on, for example, a rear surface of the display panel 21, a frame 23 having an letter “L” shape and fixed to a lower portion of the rear surface of the display panel 21, a neck portion 15 having substantially a cylindrical shape and provided at a lower side of the frame 23, a framework member 24 which covers a front side of the display panel 21, and a back cover 25 which covers the rear surface of the display panel 21. In this embodiment, the display unit 12 comprises the neck portion 15.

The structure of the swivel unit 14 here is similar to that of the first embodiment. However, in this embodiment, the swivel portion 14 is disposed in a reverse direction to that installed in the first embodiment as shown in FIG. 18. More specifically, the first member 31 of the swivel unit 14 is secured to the display unit 12 by the first screws 36. Further, the second member 32 of the swivel unit 14 is secured to the stand 13 which is an example of the supporting portion by the second screws 37.

According to the third embodiment, the display unit 12 comprising the neck portion 15 can be rotated with respect to the stand 13. Thus, due to the high versatility of the swivel unit 14, the structural portion above the neck portion 15 can be rotated. In this manner, the swivel unit 14 can be employed by a plurality of different models, and also it can flexibly deal with design changes or the like.

Subsequently, the fourth embodiment of the electronic device will now be described with reference to FIG. 19. A television 11, which is an example of the electronic device according to the fourth embodiment is similar to that of the first embodiment in main structure except for the structure of the first member 31 of the swivel unit 14, which slightly differs from that of the first embodiment. Therefore, the portions different from those of the first embodiment will be mainly described. Here, the common parts will be designated by the same reference symbol and explanations therefore will be omitted.

The television 11 comprises a display unit 12, a stand 13 which is an example of a support portion which supports the display unit 12, and a swivel unit (joint portion) 14 connected between the stand 13 and the display unit 12. In the fourth embodiment, the swivel portion 14 is disposed in the same direction as that installed in the first embodiment.

The stand 13 comprises a neck portion 15 having substantially a cylindrical shape, and a leg portion 16 which is brought into direct contact with a table or the like, on which the television 11 is placed. The structure of the display unit 12 is similar to that of the first embodiment.

The first member 31 of the swivel unit 14 is integrated with the neck portion 15 of the stand 13 as one unit. The first member 31 comprises a first member 31A and a second surface 31B on an opposite side. The first member 31 comprises an opening portion 41, a main body 42 which defines the surrounding of the opening portion 41, and is integrated with the neck portion 15, a plurality of receiving portions 43 formed integrally to be continuous to the opening portion 41, and a total of four regulating portions 45 projecting from the main body 42 towards the shaft portion 44 of the second member 32. Further, in this embodiment, the first member 31 is integrated with the stand 13 as one unit, and therefore the first screws 36 which secure the first member 31 to the stand 13 are not provided in the swivel unit 14.

According to the fourth embodiment, the first member 31 of the swivel unit 14 is integrated with the neck portion 15 as one unit. With this structure, the number of parts is reduced and therefore the production cost of the television 11 can be reduced.

The electronic device is not limited direclty to the television 11 discussed in each of the above-described embodiments, but it naturally includes other electronic devices such as portable computers, mobile telephones and electronic book readers which electrically display books, images and the like. Here, the main body portion provided with manipuration buttons and keys corresponds to the supporting portion.

Further, the electronic device is not limited direclty to the above-described embodiment, but it can be realized while remodifying the structural elements thereof withn the scope where the essense thereof remains. Further, various types of embodiments can be achieved by combining or rearranging various structural elements dislcosed in the embodiment appropriately. For example, some of the structural elements may be deleted from the entire structure disclosed in the embodiment. Further, structural elements of varisou versions may be combined together as needed.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A television comprising:
a display;
a supporting portion; and
a swivel between the supporting portion and the display and mechanically coupling the display to rotate with respect to the supporting portion,
wherein the swivel further comprises:
a first member comprising an opening portion, a main portion surrounding the opening portion and a plurality of receiving portions in the main body, and attached to either the supporting portion or the display;
a second member comprising a shaft configured to rotate and fitted to the opening portion and an overlay portion overlay on a first surface of the first member and attached to either the supporting portion or the display not attached to the first member; and
a first lubricating portion comprising a first portion between the shaft portion and the main body, a second portion between the first surface of the first member and the overlay portion, and a plurality of projecting portions projecting from the second portion and fitted into the receiving portions, respectively, and configured to inhibit the first portion and the second portion from rotating with respect to the first member.

2. The television of claim 1, wherein
the second member comprises a first projecting portion projecting from the shaft portion towards the first member, and
the first member comprises a pair of regulating portions projecting from the main body towards the shaft portion, the first member being configured to hold the first projecting portion therebetween, and to regulate a rotation angle of the second member.

3. The television of claim 2, wherein
the swivel comprises:
a first screw configured to hold the first member and one of the supporting member and the display; and
a second screw configured to hold the second member and one of the supporting member and the display not held by the first screw, and
the pair of regulating portions each comprises a first screw hole configured to receive the first screw therethrough, and
the projecting portions each comprises a second screw hole configured to receive the second screw therethrough.

4. The television of claim 3, wherein
the plurality of receiving portions each comprises a first receiving portion and a second receiving portion comprising a width smaller than a width of the first receiving portion, and
the plurality of projecting portions each comprises a first projecting portion fitted to the first receiving portion and a second projecting portion fitted to the second receiving portion and comprising a width smaller than a width of the first projecting portion.

5. The television of claim 4, wherein each first screw hole comprises a recess portion configured to hold a head portion of the first screw therein.

6. The television of claim 5, wherein
the swivel comprises:
a third member overlaid on a second surface on an opposite side to the first surface of the first member;
a second lubricating member comprising a main body portion between the second surface of the first member and the third member, and a plurality of protrusion portions protruding from the main body portion and fitted to the plurality of receiving portions, respectively, and configured to inhibit the main body portion from rotating with respect to the first member, and
a third screw configured to hold the second member and the third member together and to compress the second lubricating member between the first member and the third member.

7. The television of claim 6, wherein
the third member comprises an engaging portion, and
the second member comprises a second projecting portion projecting from the shaft portion and fitted into the engaging portion and configured to inhibit the third member from rotating with respect to the second member.

8. An electronic device comprising:
a display;
a supporting portion; and
a coupling module configured to couple the supporting portion and the display to rotate with respect to each other,
wherein the coupling module further comprises:
a first member comprising an opening portion and a receiving portion, and attached to either one of the supporting portion and the display;
a second member comprising a fitting portion fitted to rotate to the opening portion and an overlay portion overlay on a first surface of the first member, and attached to the other one of the supporting portion and the display; and
an intermediate member comprising a first portion between the fitting portion and the main body, a second portion between the first surface of the first member and the overlay portion, and a projecting portion projecting from the second portion and fitted into the receiving portion.
